(19) United States
(12) Patent Application Publication
(10) Pub. No.: US 2002/0091589 A1
(43) Pub. Date: Jul. 11, 2002

(54) System and method for customizing a product

(76) Inventors: Akimasa Ohta, Tokyo (JP); Hisaharu Sakamoto, Tokyo (JP)

Correspondence Address: McGinn & Gibb, PLLC, Suite 200, 8321 Old Courthouse Road, Vienna, VA, 22182-3817, US

(21) Appl. No.: 10/032,568

(22) Filed: Jan. 2, 2002

(30) Foreign Application Priority Data
Jan. 10, 2001 (JP) 2001-002556

(51) Int. Cl. G06F 17/60

(52) U.S. Cl. 705/27; 705/39

(57) ABSTRACT

A custom-made product providing system allowing a customer to easily select desired components from a wide variety of components is disclosed. A plurality of component maker servers is connected on the Internet, each of which provides component information of a component made by a corresponding component maker on the computer network. A manufacturer server provides a site on the Internet and the site provides a page containing a plurality of selectable items corresponding to component information of respective ones of components made by different component makers. A customer terminal connects to the site via the Internet and the customer customizes the product by selectively determining the selectable items on the page.

### BACKGROUND OF THE INVENTION

1. Field of the Invention

The present invention relates to a so-called built-to-order manufacturing system, and in particular to a system and method of customizing a product via a network.

2. Description of the Related Art

There has been an assembly service providing a custom-made product, which is assembled depending on an order received from a purchaser via a network such as the Internet. Typically, on an Internet home page of the assembly service provider, a basic model of the produce and its optional components or parts are presented on a browser running on the purchaser's computer. The purchaser can select desired ones of the presented components to build a desired product through the browser.

A components management system using the Internet has been disclosed in Japanese Patent Application Unexamined Publication No. P2000-235582A. More specifically, a search server having components information retrievably therein provides a client with component information depending on a client's instruction. When the client clicks a button for displaying details of the component, the detailed information is displayed on the client's browser. When clicking another button for displaying component-related home pages, the client's computer is linked to a corresponding component-related home page through the Internet.

In the above assembly service system, however, purchasers can select a desired one from only a limited variety of components that is determined by the assembly service provider. Accordingly, when a component desired by the client is not presented on the home page of the assembly service provider, the purchaser cannot get such components vie the home page. In this case, the purchaser must purchase such a component and install it on the product by oneself.

In the components management system as described above, it is possible for the client computer to be linked to a component-related home page. However, since the component-related home page is provided by a component provider or manufacturer, only components information related to the target product is not always displayed on the client's browser. In other words, components information that is not related to or compatible with the client's product may be frequently displayed with mixed with the components information related to the target product, resulting in inconvenience of having to find related components from them.

Further, in the case where the components management system as described above is applied to the above assembly service system, the client will find it inconvenient to select desired components to add them to the basic model on the home page because the client computer must be linked to a component-related home page each time a related component that is not presented in the home page is selected.

### SUMMARY OF THE INVENTION

An object of the present invention is to provide a system and method allowing a customer to easily select desired components from a wide variety of components related to a target product.

According to the present invention, a system for customizing a product via a computer network, includes: a plurality of component maker servers, each of which provides component information of a component made by a corresponding component maker on the computer network, wherein the component is used for the product; a manufacturer server providing a site on the computer network, wherein the site provides a page containing a plurality of selectable items corresponding to component information of respective ones of components made by different component makers; and a customer terminal connected to the site via the computer network to present the page, wherein the product is customized by selectively determining the selectable items on the page.

The manufacturer server may access each of the component maker servers to store component information of a component made by the corresponding component maker.

When identifying data of a component which is not stored in the manufacturer server is received from the customer terminal, the manufacturer server may use the identifying data to access a corresponding component maker server and stores component information of that component.

The manufacturer server may include a component server for retrievably storing component information, wherein the component server is updated when new component information is received from a component maker server.

The system may further include a banking institution on the computer network, for transferring an amount paid for the product from a customer's account to a manufacturer's account in response to a transfer request received from the manufacturer.

According to another aspect of the present invention, a method for customizing a product via a computer network, includes the steps of: acquiring component information of components made by different component makers from component maker servers thereof; publishing a home page on the computer network, wherein the home page contains a plurality of selectable items corresponding to respective ones of components made by the different component makers; and customizing the product by using components selected from the selectable items depending on an instruction received from a customer via the computer network.

The component information of components may be updated when acquiring new component information from the component maker servers.

According to further another aspect of the present invention, a method for customizing a product on a home page published on a computer network, includes the steps of: providing a plurality of selectable items corresponding to respective ones of components made by different component makers on the home page, wherein component information of the components have been acquired from servers of the different component makers; customizing the product depending on which one of the selectable items is clicked in a customer's terminal; and requesting payment for the product from a banking institution depending on account information received from the customer's terminal.

As described above, the manufacturer acquires components information from plural component makers and the acquired components information is provided to allow the customer to select a desired one from a wide variety of components. Accordingly, the customer can get a custom-made product with higher originality.

Further, when a component other than the components presented by the manufacturer server is designated by a customer, the manufacturer accesses a corresponding component maker server to acquire the component information of the component in question. Accordingly, the customer can select a desired one from a wider range of choices.

### BRIEF DESCRIPTION OF THE DRAWINGS

FIG. 1 is a diagram showing a network employing a customizing system according to a first embodiment of the present invention;

FIG. 2 is a diagram showing a sequence of a product customizing operation according to the first embodiment of the present invention;

FIG. 3 is a diagram showing a sequence of a product customizing operation according to a second embodiment of the present invention;

FIG. 4 is a schematic diagram showing an example of a home page in the embodiments of the present invention; and

FIG. 5 is a schematic diagram showing an example of a home page when a customizing button has been clicked in the image of FIG. 4.

### DESCRIPTION OF THE PREFERRED EMBODIMENTS

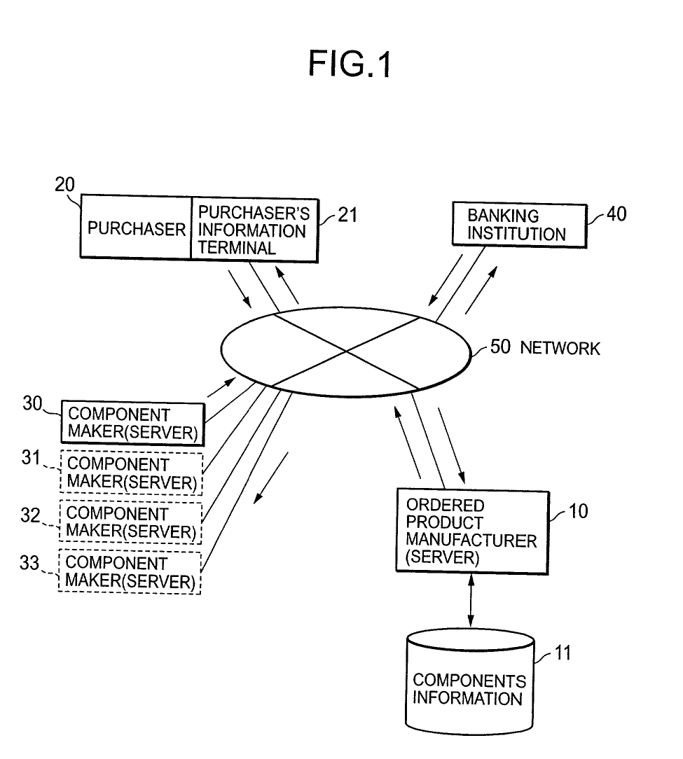

Referring to FIG. 1, a customizing system according to a first embodiment of the present invention is composed of an ordered product manufacturer 10 connected to a components information database 11, an information terminal 21 such as a personal computer of a purchaser (or a customer) 20, a plurality of component makers 30-33, and a banking institution 40, which can communicate with each other through a network 50 that may be a computer network such as the Internet. Although not shown in FIG. 1, the ordered product manufacturer 10, the component makers 30-33, and the banking institution 40 are each provided with servers or terminals connected to the network 50 to perform a customizing operation according to the present embodiment as described later.

The ordered product manufacturer 10 is a personal computer maker, a car maker, a software maker, or the like, and may be also a component maker. The ordered product manufacturer 10 acquires components information from the respective component makers 30-33 through the network 50 and stores them in the server. Component information of a component includes the type, price, delivery time and the like thereof. The components information acquired from the respective component makers 30-33 is contained in the home page established by the ordered product manufacturer 10. Accordingly, the components information is selectively provided to the purchaser 21 depending on an access request of the purchaser 20, which will be described later.

The information terminal 21 may be a personal computer provided with an input device such as a keyboard, a communication device, and a display. The information terminal 21 is installed with a browser allowing the computer to access and display the home page of the ordered product manufacturer 10. Accordingly, the purchaser 20 operates the input device to create an order designating a basic model, desired components to be added to the basic model, total budgeted amount, and an account number for payment, and then transmit it to the ordered product manufacturer 10 through the network 50.

Each of the component makers 30-33, in response to a component information request from the ordered product manufacturer 10, transmits components information thereto. When receiving an order for a certain component from the ordered product manufacturer 10, the component maker delivers the component to the ordered product manufacturer 10 or, in the case of a software program, may transmit it to the ordered product manufacturer 10 via the network 50. The number of component makers is not limited to four as shown in FIG. 1. An increasing number of component makers will extend the range of choices for purchasers.

The banking institution 40 provides so-called Internet banking. At the request of the ordered product manufacturer 10, the banking institution 40 transfers a total amount billed from the account of the purchaser 20 to the account of the ordered product manufacturer 10.

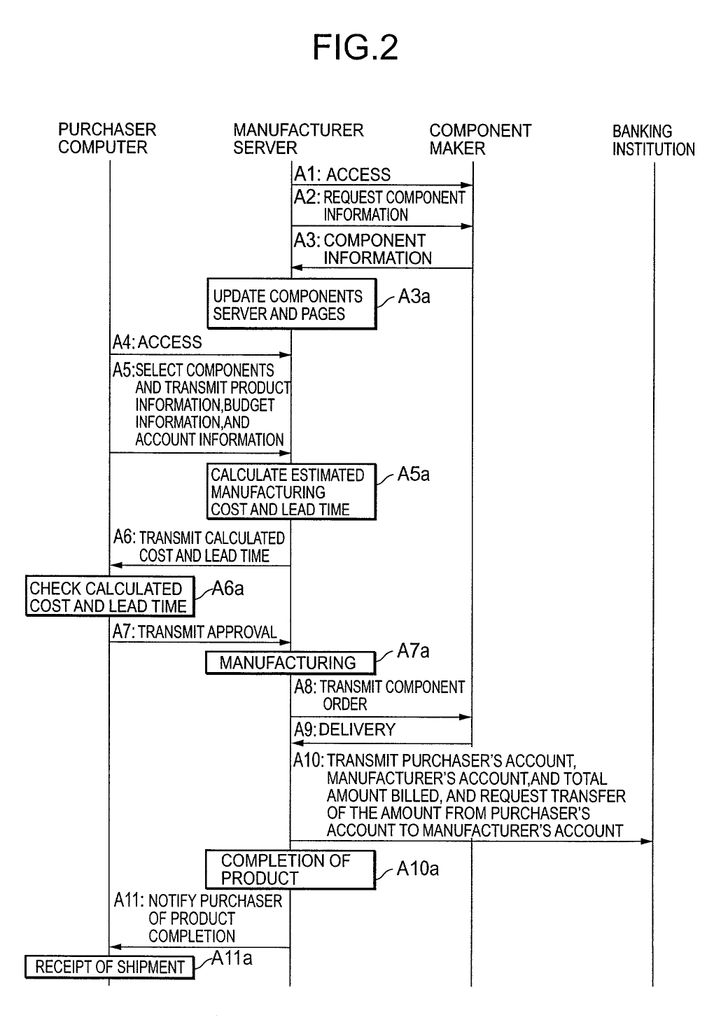

An example of an operation of the system of FIG. 1 will be described with reference to FIG. 2.

Referring to FIG. 2, the ordered product manufacturer 10 accesses each of the component makers 30-33 via the network 50 (step A1) and requests components information from each component maker (step A2) . When receiving the component information request, each component maker transmits requested component information to the ordered product manufacturer 10 (step A3).

The ordered product manufacturer 10 receives the components information from each of the component makers 30-33 and stores the received components information into the server. When the server has already stored components information, the existing components information is updated by the newly received components information. Thereafter, the stored or updated components information is contained in the home page and related pages on the server (step A3a). The above steps A1 to A3a are performed as necessary to keep the contained components information up to date so as to provide the latest components information to the purchaser 20.

The purchaser 20 operates the information terminal 21 to access the homepage of the ordered product manufacturer 10 through the network 50 (step A4). The purchaser 20 can select desired components from a wide variety of components contained in the homepage. The purchaser 20 enters desired product information, the selected components information, a total budgeted amount, an account number for payment, and other necessary information to transmit them to the ordered product manufacturer 10 (step A5).

When having received necessary information for the order of the product from the purchaser 20, the ordered product manufacturer 10 estimates the manufacturing cost and lead time based on the information of the order (step A5a) and transmits the results back to the purchaser 20 (step A6).

The purchaser 20 checks the estimated manufacturing cost and lead time received from the ordered product manufacturer 10 (step A6a) . When the purchaser 20 approves, an approval result is transmitted to the ordered product manufacturer 10 (step A7). When receiving the approval from the purchaser 20, the ordered product manufacturer 10 starts assembling the ordered product using the components selected by the purchaser 20 (step A7a) If out of stock, the ordered product manufacturer 10 transmits an order for the out-of-stock component to a corresponding component maker (step A8) and thereby the necessary component is delivered (step A9).

The ordered product manufacturer 10 transmits the following information based on the order to the banking institution 40: the account number of the purchaser 20, the account number of the ordered product manufacturer 10, and the total amount billed, together with a request for transfer of the total amount billed from the purchaser's account to the account of the ordered product manufacturer 10 (step A10) . According to the transfer request, the banking institution 40 transfers the total amount billed from the purchaser's account to the account of the ordered product manufacturer 10. The step A10 may be performed after completion of the ordered product.

When the ordered product has been completed (step A10a), the ordered product manufacturer 10 notifies the purchaser 20 of completion of the ordered product (step A11) . When receiving the product completion notice, the purchaser 20 receives the custom-made product as appropriate from the ordered product manufacturer 10 (step A11a) . The custom-made product may be delivered from the ordered product manufacturer 10 to the purchaser 20 or the purchaser 20 may visit a place specified by the ordered product manufacturer 10 to receive the custom-made product.

If the purchaser 20 does not approve the estimated amount and lead time required for manufacturing at the step A6a, the purchaser 20 can change the condition of components, for example, a maker and a total budgeted amount.

The steps A5 to A6a are repeatedly performed until the purchaser 20 approves. When the purchaser 20 has never approved, the purchaser 20 transmits a check result to the ordered product manufacturer 10 to notify that the business is broken off and then the process is terminated.

In this manner, the ordered product manufacturer 10 acquires components information from plural component makers and the acquired components information is provided to allow the purchaser 20 to select a desired one from a wide variety of components. Accordingly, the purchaser 20 can get a custom-made product with higher originality. Since the account information of the purchaser 20 is transmitted to the ordered product manufacturer 10 when ordering, the amount billed is automatically paid from the purchaser's account by the banking institution 40.

As described above, according to the first embodiment, the purchaser 20 selects a desired one from the components acquired from the component makers 30-33.

According to a second embodiment of the present invention, the home page is designed to prompt the purchaser 20 to enter the type, model, and maker of a component that is not contained in the component list on the homepage. If such data is not inputted, the manufacturing cost and lead time cannot be calculated because no information of the selected component is stored in the server.

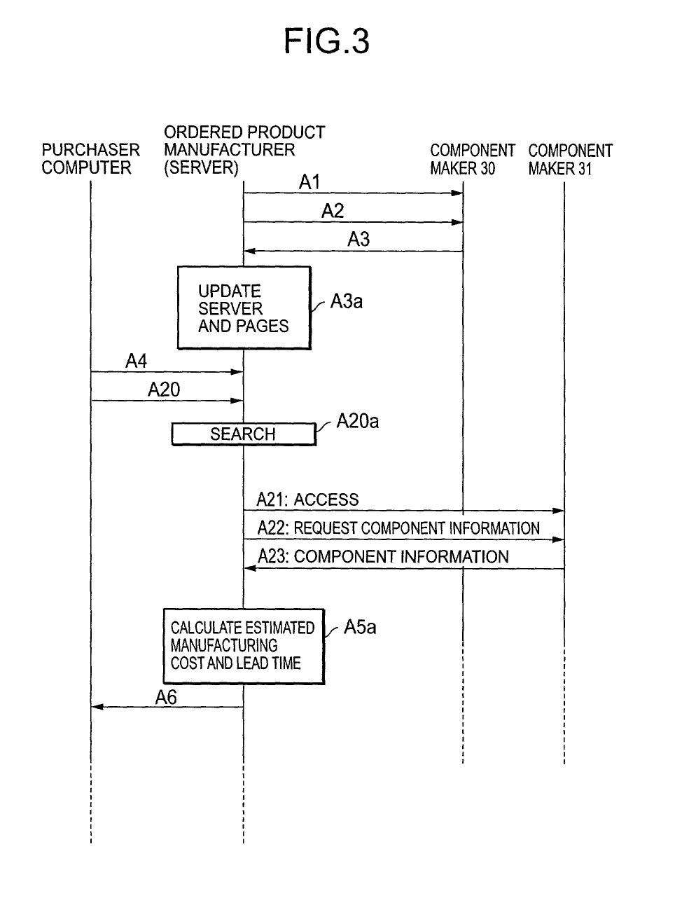

Referring to FIG. 3, after the step A4, the purchaser 20 enters desired product information, the selected component information, a total budgeted amount, an account number for payment, and other necessary information such as the type, model, and maker of a component that is not contained in the page and transmits them to the ordered product manufacturer 10 (step A20). When having received such information from the purchaser 20, the ordered product manufacturer 10 searches the server to determine whether all components in the order are contained in the server (step A20a) . When the component that is not contained in the page is found, the ordered product manufacturer 10 accesses the server of a corresponding component maker (step A21) and requests component information of the component identified by the type and model thereof from the corresponding component maker (step A22) . When receiving the component information request, the component maker transmits price, lead time, and other necessary information of the selected component to the ordered product manufacturer 10 (step A23).

The ordered product manufacturer 10 receives the component information of the selected component from the corresponding component maker and stores the received component information into the server. Based on the information of the selected component received from the component maker, the ordered product manufacturer 10 calculates the manufacturing cost and the lead time thereof to provide the purchaser 20 on the home page and then waits for the approval from the purchaser 20 (steps A5a and A6) The steps other than the steps 20a to 25 are the same as those shown in FIG. 2, which are therefore denoted by the same reference symbols and are in part omitted in FIG. 3. In the second embodiment, since the purchaser 20 can select a component other than the components presented by the ordered product manufacturer 10, the purchaser 20 can select a desired one from a wider range of choices and therefore obtain an original product.

Hereafter, it is assumed as an example that the ordered product manufacturer 10 is a personal computer maker that manufactures a custom-made computer.

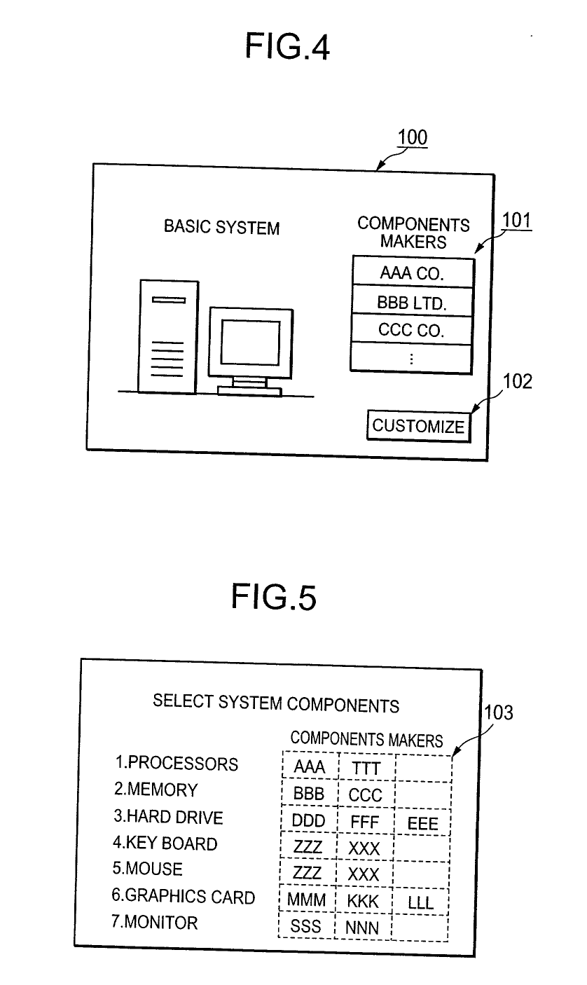

Referring to FIG. 4, a basic system page 100 is displayed on a monitor of the purchaser's computer 21. The basic system page 100 contains a list of component makers 101, each of which provides component information thereof. When the purchaser 20 clicks a customize button 102 on the basic system page 100, a component selection page is displayed as shown in FIG. 5.

In FIG. 5, a list of components required for or optionally selected for the product is displayed on the component selection page. For each of the components, the names 103 of component makers providing a corresponding component are displayed. For example, in the case of hard disk drive, three HDD makers (here, DDD, FFF, and EEE) are registered. When the purchaser 20 clicks a desired one of the three HDD makers, a list of hard disk drives provided by the desired maker is displayed. When the purchaser 20 clicks a desired component, the components provided by all corresponding makers are listed. For example, when “Processors” is clicked, a list of processors provided by the two makers (here, AAA and TTT) is displayed. Accordingly, the purchaser 20 can select a desired one from such wide range of choices.

1. A system for customizing a product via a computer network, comprising:
a plurality of component maker servers, each of which provides component information of a component made by a corresponding component maker on the computer network, wherein the component is used for the product;
a manufacturer server providing a site on the computer network, wherein the site provides a page containing a plurality of selectable items corresponding to component information of respective ones of components made by different component makers; and
a customer terminal connected to the site via the computer network to present the page, wherein the product is customized by selectively determining the selectable items on the page.

2. The system according to claim 1, wherein the manufacturer server accesses each of the component maker servers to store component information of a component made by the corresponding component maker.

3. The system according to claim 1, wherein, when identifying data of a component which is not stored in the manufacturer server is received from the customer terminal, the manufacturer server uses the identifying data to access a corresponding component maker server and stores component information of that component.

4. The system according to claim 2, wherein the manufacturer server comprises a component server for retrievably storing component information, wherein the component server is updated when new component information is received from a component maker server.

5. The system according to claim 1, further comprising:
a banking institution on the computer network, for transferring an amount paid for the product from a customer's account to a manufacturer's account in response to a transfer request received from the manufacturer.

6. A method for customizing a product via a computer network, comprising the steps of:
acquiring component information of components made by different component makers from component maker servers thereof;
publishing a home page on the computer network, wherein the home page contains a plurality of selectable items corresponding to respective ones of components made by the different component makers; and
customizing the product by using components selected from the selectable items depending on an instruction received from a customer via the computer network.

7. The method according to claim 6, where in the component information of components are updated when acquiring new component information from the component maker servers.

8. The method according to claim 6, further comprising the step of:
when receiving identifying data of a component which has never been acquired from the customer, accessing a component maker server identified by the identifying data to acquire component information of the component.

9. The method according to claim 6, further comprising the step of:
at a banking institution on the computer network,
transferring an amount paid for the product from a customer's account to a manufacturer's account.

10. A method for customizing a product on a home page published on a computer network, comprising the steps of:
providing a plurality of selectable items corresponding to respective ones of components made by different component makers on the home page, wherein component information of the components have been acquired from servers of the different component makers;
customizing the product depending on which one of the selectable items is clicked in a customer's terminal; and
requesting payment for the product from a banking institution depending on account information received from the customer's terminal.
